(19) United States
(12) Patent Application Publication
(10) Pub. No.: US 2010/0142790 A1
(43) Pub. Date: Jun. 10, 2010

(54) IMAGE PROCESSING METHOD CAPABLE OF ENHANCING CONTRAST AND REDUCING NOISE OF DIGITAL IMAGE AND IMAGE PROCESSING DEVICE USING SAME

(75) Inventor: Jimmy Chang, Taipei (TW)

Correspondence Address: KIRTON AND MCCONKIE, 60 EAST SOUTH TEMPLE,, SUITE 1800, SALT LAKE CITY, UT, 84111, US

(73) Assignee: NEW MEDICAL CO., LTD., Taipei (TW)

(21) Appl. No.: 12/328,650

(22) Filed: Dec. 4, 2008

(51) Int. Cl. G06K 9/40; G06K 9/00

(52) U.S. Cl. 382/132; 382/274; 382/264; 382/261

(57) ABSTRACT

An image processing method is provided and comprises the steps of: (a) decomposing an original image into a plurality of detail images at successive resolution levels; (b) enhancing image contrast and reducing noise of each the detail image; and (c) reconstructing the processed detail images into an output image.

### FIELD OF THE INVENTION

The present invention relates to an image processing method and image processing device, and more particularly to an image processing method capable of enhancing contrast and reducing noise of digital image and an image processing device using the same.

### BACKGROUND OF THE INVENTION

Due to recent advances in digital technology, radiographic image may now be converted into digital image signal. These digital image signals are subjected to image processing, and the processed digital image signals are displayed on a display device or outputted onto a film. The usual objective in radiography is to produce an image showing the highest amount of detail possible. This requires careful control of a number of different variables that can affect image quality. Radiographic contrast is the degree of density difference between two areas on a radiograph. Radiographic contrast makes it easier to distinguish the features of interest, such as defect, from the surrounding areas. Radiographs often contain large variations of radiographic density together with detail information of only very weak contrast. For instance, in a chest image mediastinum and thoracic spine absorb strongly, while the lungs are almost x-ray transparent. A similar situation occurs when imaging metal implants, like artificial hip joints, which exhibit very large x-ray attenuation relative to surrounding tissue.

Hard or softcopy display of such images then often faces the dilemma of having to reproduce these large variations without clipping, while at the same time subtle details, like lung nodules, must remain visible. In digital radiography, suitable image processing can help to reconcile some of the problems faced in the display of radiographic images. It can help to meet the conflicting requirements of reproducing the low-contrast details without clipping the general gray-value range. Many attempts have been made to solve this problem, such as the commonly known technique of un-sharp masking, adaptive histogram equalization, and the many variants on these generic methods, but all suffer to some extent from the shortcoming that ringing or Gibbs effect, called artifacts are created in the vicinity of significant signal level transitions, which occur at for example bone/soft tissue boundaries within the image. These artifacts cause a serious problem since they might suggest pathological evidence in a normal radiograph, or in other cases such artifacts might hide subtle lesions.

A standard technique for the enhancement of small details (i.e., edges) and improvement of global contrast is un-sharp masking, where the image is split up into two, three or more frequency channels. The edge image is then amplified and added again to the corresponding low-pass image. In the case where the image is split into three or more frequency channels, contrast equalization can be achieved by additionally applying a dynamic range compression to the low-pass image. Clearly, this provides no access to structures of intermediate sizes. Therefore, various multi-scale methods have been proposed recently, where the image is split up into a larger number of frequency channels, which can then be processed separately.

Multi-scale techniques are widely used in the algorithms for processing, analysis and coding of images. In a multi-scale decomposition, the information contained in a signal is arranged into a conceptually meaningful hierarchy, which can present a basis for coarse-to-fine processing or analysis. The objective of image enhancement is to improve the visibility of low contrast features while suppressing the noises. As an example of multi-scale representations, the Laplacian Pyramid (LP) has been used for image enhancement by the extrapolation of high frequency information. The Laplacian Pyramid scheme proposed by Burt and Adelson is presented in “THE LAPLACIAN PYRIAMID AS A COMPACT IMAGE CODE”, IEEE, Transactions on Communications, vol. com-31, No 4, April 1983. The original image is preprocessed by a low-pass filter and sub-sampled by factor two. Then the intermediate result is interpolated to the original image size and pixel-wise subtracted from the original image. Such process is iterated on the coarse version until a sub-sampled image comprising only one pixel, which is the DC component of the image. The basic idea in multi-scale enhancement is to operate on these components rather than on the original image.

There exist several multi-scale image enhancement methods, such as multi-scale contrast enhancement, non-linear extrapolation in frequency space, and wavelet based algorithm for X-ray image de-noising and enhancement. However, most of these methods are applied to special images, such as X-ray images, not for generic images. In P. Vuylsteke and E. Schoeter's method, the edge enhancement is implemented by multiplying the pyramid coefficients of the different scale layers with a scale-dependent factor, but the different part with different significance of each scale layer is not taken into account. And in Greenspan and Anderson's methods, a high-frequency component is predicted at 0th scale, but the different significance of different scale is not taken into account.

In medical image processing, wavelet methods have been used for many purposes, e.g., in the context of segmentation, registration, noise reduction, or compression of images. Mostly, these applications used wavelet methods for the multi-scale decomposition of the signal. However, when it is applied to digital radiographs, it is found that wavelet approaches are also sensitive to ringing or Gibbs effect.

In views of the above-described disadvantages resulted from the prior art, the applicant keeps on carving unflaggingly to develop an image processing method capable of enhancing contrast and reducing noise of digital image and an image processing device using the same through wholehearted experience and research.

### SUMMARY OF THE INVENTION

It is a principal object of the present invention to provide an image processing method for improving global contrast of a digital image.

It is a further object of the present invention to provide an image processing method capable of enhancing contrast and reducing noise of digital image for use in medical imaging system, for example in a medical radiographic imaging system such as digital radiography system or computed radiography system.

It is a still object of the present invention to overcome the drawbacks of prior art methods and improve the visibility of low contrast features while suppressing the noises of a digital image.

It is a still further object of the present invention to provide an image processing method, which is fast enough to be suitable for noise reduction in high rate imaging.

To achieve the above-mentioned objects, the present invention proposes an improved image enhancement algorithm via the Laplacian Pyramid, which uses the contrast equalization, edge enhancement, de-noise and so on to deal with different parts of each Laplacian Pyramid scale and different scales of Laplacian Pyramid. The objective of this algorithm is to emphasize the medium-contrast details of each stage and the objective enhancement is to enhance the details with lower magnitude more than the details with higher magnitude. The contrast improvement ratios (CIRs) of most images are increased while preserving the good visual assessment of X-ray images.

To achieve the above-mentioned objects, the present invention chooses Laplacian Pyramid transformation as multi-scale kernel. Then it process edge coefficient at each Laplacian Pyramid layer. The Laplacian Pyramid was introduced by Burt and Adelson in the context of compression of images. It has the advantage that the image is only expanded to 4/3 of the original size and that the same (small) filter kernel can be used for all Laplacian Pyramid levels.

In accordance with a first aspect of the present invention, an image processing method is provided and comprises the steps of: (a) decomposing an original image into a plurality of detail images at successive resolution levels; (b) enhancing image contrast and reducing noise of each the detail image; and (c) reconstructing the processed detail images into an output image.

In accordance with a second aspect of the present invention, an image processing device for processing an original image into an output image is provided and comprises: an image decomposing section configured to receive the original image and decompose the original image into a plurality of detail images at successive resolution levels; an image processing section coupled to the image decomposing section for enhancing image contrast and reducing noise of each the detail image; and an image reconstructing section coupled to the image processing section for reconstructing the processed detail images into the output image.

In accordance with a third aspect of the present invention, an X-ray examination apparatus is provided and comprises: an image picking-up device for picking-up an original image; an image processing device coupled to the image pick-up device and comprising an image decomposing section configured to receive the original image and decompose the original image into a plurality of detail images at successive resolution levels, an image processing section coupled to the image decomposing section for enhancing image contrast and reducing noise of each the detail image, and an image reconstructing section coupled to the image processing section for reconstructing the processed detail images into the output image; and an image output device coupled to the image processing device for outputting the output image.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a simplified block scheme illustrating an image processing device according to a preferred embodiment of the present invention;

FIG. 2 is a detailed block diagram of producing the output image by using the image processing device of FIG. 1;

FIG. 3 is the schematic block diagram of REDUCE operator in the image decomposing section of FIG. 2;

FIG. 4 is the schematic block diagram of EXPAND operator in the image decomposing section of FIG. 2;

FIG. 5 is the schematic block diagram of process operator of the image processing section of FIG. 2;

FIG. 6 shows a schematic representation of nonlinear amplification applied to the laplacian pyramid coefficients; and

FIG. 7 is the various nonlinear mapping curve according to the preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

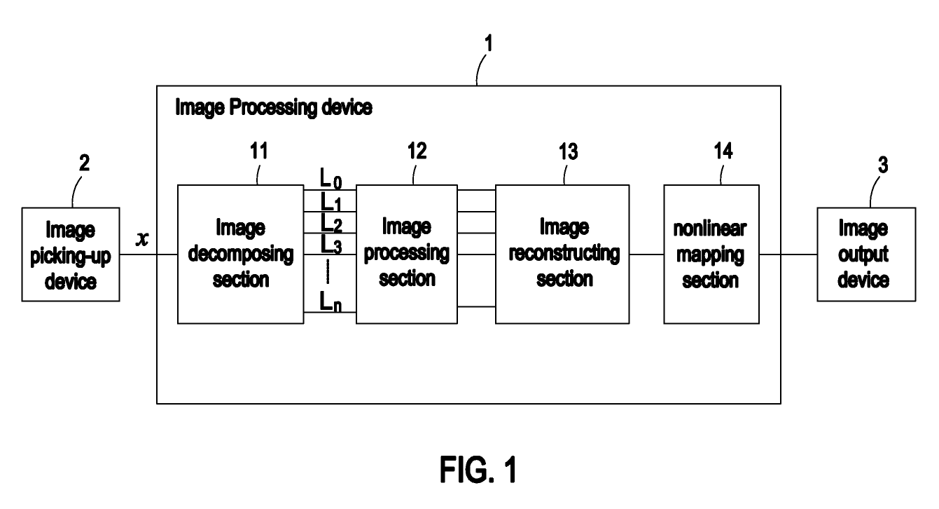

Please refer to FIG. 1, which is a simplified block scheme illustrating an image processing device according to a preferred embodiment of the present invention. As shown in FIG. 1, the image processing device 1 is coupled to an image picking-up device 2 and an image output device 3 for receiving a digital image x (also called raw or original image) form the image picking-up device 2, processing and enhancing the digital image x and outputting the processed digital image via the image output device 3, which produce either a hardcopy on transparent film or on paper, or a viewable image on a display monitor.

The image processing device 1 of the present invention comprises at least three sections comprising an image decomposing section 11, an image processing section 12 and an image reconstructing section 13. The image decomposing section 11 is employed to receive the original image x from the image picking-up device 2 and decomposes the original image x into a plurality of detail images, for example N levels of the detail images, which represent the amount of detail present in the original image at multiple resolution levels, from fine to coarse. The image processing section 12 is employed to enhance the image contrast and remove noise of each detail image. In an embodiment, the image processing section 12 is also employed to further enhance the image edge of each detail image. In addition, the image reconstructing section 13 is employed to reconstruct the processed image by combining all levels of the detail images processed by the image processing section 12. In some embodiment, a nonlinear mapping section 14 is employed to transfer the processed image to other dynamic range of digital image, for example 8 bits data of digital radiograph so as to provide viewable image on a display monitor.

Referring to FIG. 1, the image processing method implemented by the image processing device 1 according to the preferred embodiment of the present invention is described as follows. As shown in FIG. 1, an original image x is provided from the image picking-up device 2 and received by the image decomposing section 11 of the image processing device 1. The image decomposing section 11 performs an image decomposing procedure by using Laplacian Pyramid Transform to obtain N levels of the detail images, wherein the N levels of detail images are multi-resolution Laplacian Pyramid images. Namely, the original image x is decomposed into a plurality of detail images, for example N levels of the detail images Lᵢ (i=0, 1˜N), which represent the amount of detail present in the original image x at multiple resolution levels, from fine to coarse. The number of levels of pyramid, N, is determined based upon the maximum size of the object of interest. The larger the size of the object of interest, the more levels that should be used.

Thereafter, the N levels of the detail images Lᵢ (i=0, 1˜N) are separately processed by the image processing section 12. The image processing section 12 performs the image process procedure to enhance the image contrast and remove noise of the each level of the detail images. In some embodiment, the image process step further comprises step of enhancing the edge of each detail image. Then, the processed original image is reconstructed by the image reconstructing section 13. The image reconstructing section 13 performs the image reconstructing procedure to combine each level of the processed detail images to output a processed original image. In some embodiment, the processed original image is transferred into other dynamic range of digital image by a nonlinear mapping section 14. The nonlinear mapping section 14 performs the image transferring step to transfer the processed original image to other dynamic range of digital image, for example 8 bits data of digital radiograph.

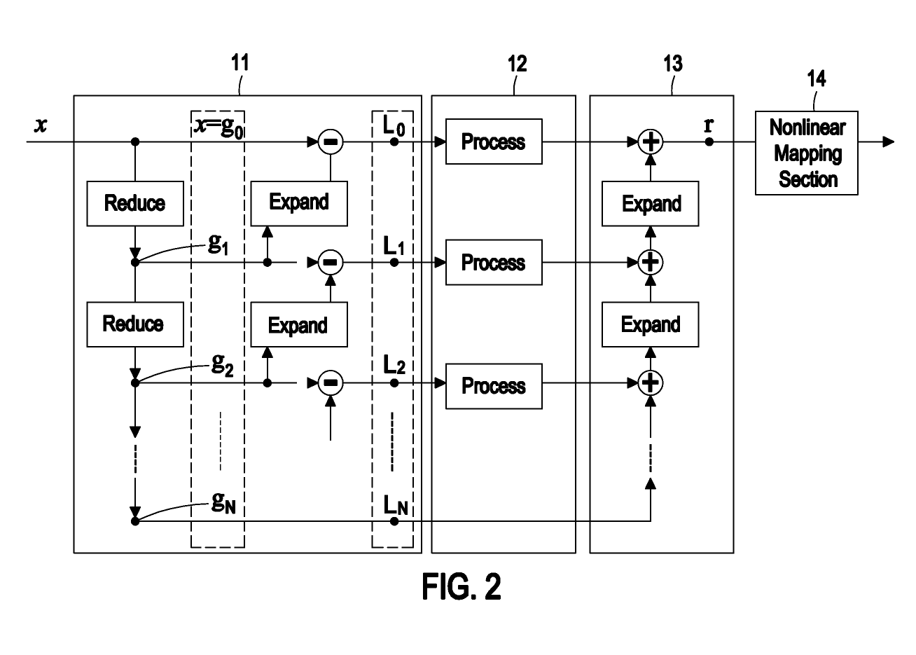

FIG. 2 is a detailed block diagram of producing the output image by using the image processing device of FIG. 1. As shown in FIG. 2, the original image x is fed into the image processing device 1 and received by the image decomposing section 11 of the image processing device 1, which carries out the image decomposing procedure. A preferred embodiment of the image decomposing procedure is described as follows. The image decomposing procedure comprises the steps of: decomposing the original image x into a plurality of reduced images at successively smaller size; interpolating the plurality of reduced images into a plurality of expanded images; and generating at least one of the plurality of detail images by subtracting one of the plurality of expanded images of a given size from one of the plurality of reduced image of the given size. The reduced images are multi-resolution images with successive resolution levels. The multi-resolution images and the detail images are the Gaussian Pyramid images and the Laplacian Pyramid images respectively. The level 0 of the multi-resolution images is the original image and top level.

For example, the level 1 of the Gaussian Pyramid g₁ is obtained by low-pass filtering and decreasing resolution of the level 0 of the Gaussian Pyramid g₀ (equals to the original image x ). It is said that g₁ is a “reduced” version of g₀ in that both resolution and sample density are decreased. In a similar way, Gaussian Pyramid g₂ is formed as a reduced version of g₁, and so on. Filtering is performed by a procedure equivalent to convolution with one of a family of local, symmetric weighting functions. An important member of this family resembles the Gaussian probability distribution, so the sequence of the images g₀, g₁, . . . , g_{N} is called the Gaussian Pyramid images.

A fast algorithm for generating the Gaussian Pyramid images is given in the following subsection. In the next subsection, it shows how the same algorithm can be used to “expand” an image array by interpolating values between sample points. This device is used here to help visualize the contents of levels in the Gaussian Pyramid images and in the next section to define the Laplacian Pyramid images. For example, the level 0 of the Laplacian Pyramid images L₀ is obtained by Expanded level 1 of the Gaussian Pyramid images g₁ subtract from the level 0 of the Gaussian Pyramid images g₀.

Suppose the image is represented initially by the array g₀ which contains C columns and R rows of pixels. Each pixel represents the gray level at the corresponding image point by an integer I between 0 and K−1, for example 0˜255. This image g₀ becomes the bottom or zero level of the Gaussian Pyramid images. The Gaussian Pyramid images level 1 contains image g₁, which is reduced or low-pass filtered version of g₀. Each value in level 1 is computed as a weighted average of values in level 0 within a 5-by-5 window. Each value within level 2, representing g₂, is then obtained from values within level 1 by applying the same pattern of weights. The size of the weighting function is not critical. A 5-by-5 pattern is preferably selected because it provides adequate filtering at low computational cost.

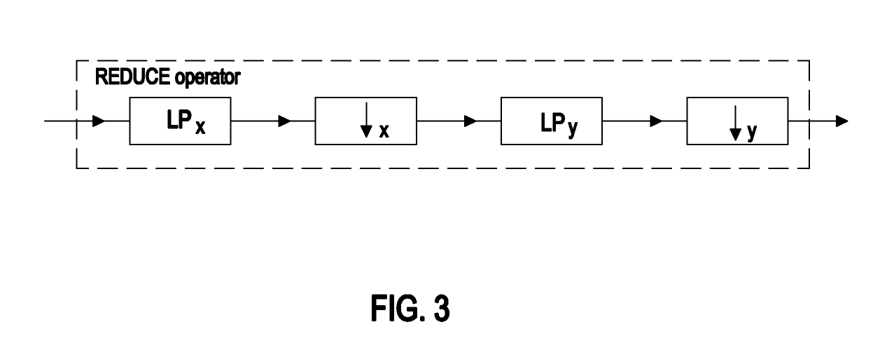

Please refer to FIG. 3, which is the schematic block diagram of REDUCE operator in the image decomposing section of FIG. 2. The level-to-level averaging process for the Gaussian Pyramid images is performed by the function of REDUCE.

g₁=REDUCE(gₗ₋₁)

The REDUCE operator comprises low-pass filtering and sub-sampling for each one dimension. The image is two dimensions so the REDUCE operator is to low-pass filter and sub-sample the x and y direction of the image respectively. In this embodiment, the factor of the sub-sampling for x and y direction is two, which means, for levels 0<l<N and nodes i, j, 0≦i<Cₗ, 0≦j<Rₗ,

$${g}_{l} ( i , j ) = {\sum }_{m = - 2}^{2} {\sum }_{n = - 2}^{2} w ( m , n ) {g}_{l - 1} ( 2 i + m , 2 j + n )$$

Here N refers to the number of levels in the Gaussian Pyramid images, while Cₗ and Rₗ are the dimensions of the lth level that the density of nodes is reduced by half in one dimension, or by a fourth in two dimension from level to level. And w(m,n) is the low-filter coefficients. In this embodiment, the low-filter is Gaussian low-filter, therefore the low-filter coefficients are Gaussian coefficients. The dimension of the original image x are appropriate for pyramid construction if integers M_{C}, M_{R} and N exist such that C=M_{C}2^{N}+1 and R=M_{R}2^{N}+1 For example, if Mc and M_{R} are both 3 and N is 5, then the original image x measure 97 by 97 pixels. The dimensions of gₗ are Cₗ=M_{C}2^{N-l}+1 and Rₗ=M_{R}2^{N-l}+1.

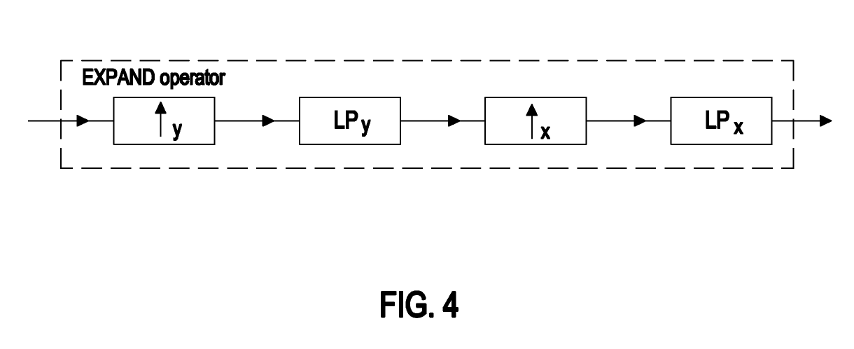

Please refer to FIG. 4, which is the schematic block diagram of EXPAND operator in the image decomposing section of FIG. 2. The function EXPAND is defined as the reverse of function REDUCE. In this embodiment, its effect is to expand an (M+1)-by-(N+1) array into a (2M+1)-by-(2N+1) array by interpolating new node values between the given values. Thus, EXPAND applied to array gₗ of the Gaussian Pyramid images would yield an array g_{l,1} which is the same size as gₗ₋₁. Let g_{l,n} be the result of expanding gₗ n times. Then g_{l,0}=gₗ and g_{l,n}=EXPAND(gₗ,n−1). By EXPAND, it means, for levels 0<l≦N and 0≦n and nodes i,j, 0≦i<Cₗ₋ₙ, 0≦j<Rₗ₋ₙ,

$${g}_{l , n} ( i , j ) = {4 \sum }_{m = - 2}^{2} {\sum }_{n = - 2}^{2} w ( m , n ) \cdot {g}_{l , n - 1} ( \frac{i - m}{2} , \frac{j - n}{2} )$$

Only terms for which (i−m)/2 and (j−n)/2 are integers are included in this sum. If EXPAND is applied to image gₗ l times, the image g_{l,l}, which is the same size as the original image g₀, is obtained. Although full expansion will not be used in image process, it is used to help one ordinary skilled in the art to visualize the contents of various arrays within pyramid structures.

The image x(m,n), m=1, . . . ,R, n=1, . . . ,C is in a first step decomposed into a Gaussian and a Laplacian pyramid representation. To this previous, two operators Reduce and Expand are defined. In this embodiment, the Reduce operator performs a two dimensional low-pass filtering followed by a sub-sampling by a factor of 2 in both directions. The Expand operator is to enlarge an image to twice the size in both directions by up-sampling (insertion of zeros) and a low-pass filter followed by a multiplication by a factor of 4 so that the expanded image has the same average intensity. Level l=0, . . . , N of the Gaussian pyramid image is defined by

g₀(m,n)=x(m,n) and gₗ(m,n)=REDUCE(gₗ₋₁(m′,n′))

The Laplacian Pyramid images is obtained by

Lₗ=gₗ(m, n)−EXPAND(gₗ₊₁(m′, n′))

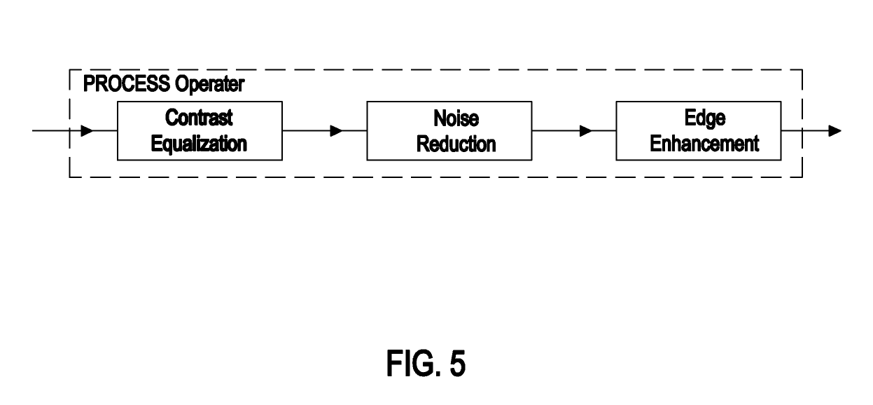

Please refer to FIG. 5, which is the schematic block diagram of process operator of the image processing section of FIG. 2. In this embodiment, the process operator comprises contrast equalization, noise removing and edge enhancement to enhance contrast, remove noise and enhance edge respectively. Whereas the Gaussian Pyramid images contains set copies of the image at different sizes, the Laplacian Pyramid Transform decomposes the original image x into a set of band pass images and a final low pass image. The value at each node in the Laplacian Pyramid images is the difference between the convolutions of two equivalent weighting function with the original image x. Again, this is similar to convolving an appropriately scaled Laplacian weighting function with the image. The node value could have been obtained directly by applying this operator. Just as the Gaussian Pyramid is viewed as a set of low-pass filtered copies of the original image x, the Laplacian Pyramid can be viewed as a set of band-pass filtered copies of the image. The scale of the Laplacian Pyramid Transform operator doubles from level to level of the Laplacian Pyramid images, while the center frequency of the pass-band is reduced by an octave.

Please refer to FIG. 2. Reconstruction of the image from the processed Laplacian Pyramid images is achieved by simply reversing the subtraction step, for example the steps of expanding and combining. If no processing took place in the Laplacian Pyramid layers, the reconstruction would exactly reproduce the original image x, a property known as perfect reconstruction. In present invention, both the Reduce and the Expand operator is based on a 5-by-5 binomial low pass filter.

The entire process of multi-scale decomposition, contrast equalization, de-noise, edge enhancement and reconstruction is pictorially exemplified in FIGS. 2 and 5. As shown in FIGS. 2 and 5, the Contrast improvement is achieved by modifying the coefficients of the Laplacian Pyramid Transform. Small coefficients represent subtle details. These are amplified in order to improve the visibility of the corresponding details. The strong density variations on the other hand have a major contribution to the overall dynamic range, and these are represented by large-valued coefficients. They can be reduced without risk of information loss, and by compressing the dynamic range, overall contrast resolution will improve. Contrast is equalized by applying the following nonlinear amplification to the transform coefficients of Laplacian Pyramid layers:

$$y ( z ) = α \frac{z}{\vert z \vert} {\vert z \vert}^{p}$$

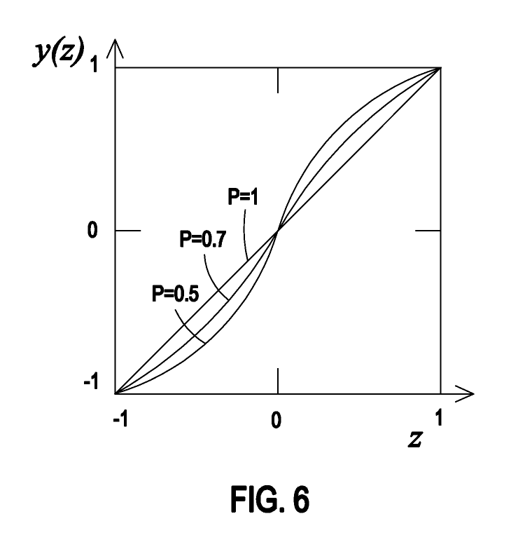

The Laplacian Pyramid coefficients z are normalized to the range [−1, 1]. The factor α is needed for resealing the resulting image to the original dynamic range. The exponent p controls the slope of the amplification curve, and hence also the amount of contrast enhancement when the image is reconstructed by applying the inverse transform to the modified Laplacian Pyramid coefficients z. The required sigmoid shape for equalization is obtained if the exponent is chosen p<1. This ensures that the smaller values are amplified relative to the larger ones. Best results are obtained in the range 0.6 through 0.9. Experience has learned that there is no need for applying stronger enhancement beyond this range, since this will not reveal any additional information, but only increase the noise impression. The curves are plotted in FIG. 6.

The most notable effect of multi-scale contrast equalization is the uniformly improved visibility of subtle features throughout the image, without really diverging from the original look. Sharpness increases, but also low-contrast opacities benefit from improved rendition. The enhancement is noticeable in poorly penetrated areas like the mediastinum, but in the lungs as well. In skeletal examinations also the soft tissue regions are properly visualized. Like with other contrast enhancement techniques, the noise is amplified simultaneously with image details. In addition, multi-scale contrast enhancement is affected by the fine-grain appearance typical of edge enhancement.

In many applications, medical images are significantly deteriorated by noise. Since this noise is due to the inherently poor signal-to-noise ratio (SNR) of the underlying physical process as in DR (digital radiograph), ultrasound or magnetic resonance (MR) or a consequence of limiting exposure of patient and medical staff to hazardous radiation as in X-ray (fluoroscopy) imaging, improvement of the imaging equipment is of little help in this respect. Instead, improvement of the visual quality has to be achieved by noise reducing processing of the acquired images. For X-ray angiograms, a spatio-temporal algorithm for harmonizing and enhancing contrast was presented at the SPIE (The International Society for Optical Engineering) medical image conference 2002. In this algorithm, a multi-scale FMH-filter was used to compensate for the additional noise induced by contrast enhancement. Further improvement of the noise reduction performance for this application was a major motivation for investigating methods for local structure adaptive filtering. In this particular case as in all single image acquisition modalities, noise reduction is restricted to intra-frame processing. Here, use has to be made of the fact that images typically contain visually important structures like edges and lines not being present in that way in noise.

Hence, noise reduction has to preserve lines and edges while removing other signal fluctuations. Linear filters do not fit for that purpose because their noise reduction affects fluctuation and edges in the same way, i.e. by blurring the image. Non-linear filtering can be based on order statistics as in 2 or based on adaptive calculation of local averages as in anisotropic diffusion. The idea of adaptive filtering is to modulate the amount of filtering, i.e. allowing full noise reduction at places without detectable image structures and switching it off where edges or lines are assumed to be present. With this approach, averaging is locally still isotropic. The approach of the present invention aims at performing noise reduction even in presence of image structures by applying locally an adaptive anisotropic filter kernel, i.e. by averaging along edges or lines. To control such an adaptive filtering, not only the strength of image structures has to be estimated but also its dominant orientation. This is achieved by calculating grey-level gradients in the image. Since gradient calculation as all derivative calculation is noise sensitive, the gradients have to be smoothed before being used. Another problem in adaptive filtering is the size of the filter kernel. In order not to destroy fine details, the kernel size has to be kept small which reduces the ability to remove low frequency noise. Such noise is especially important in X-ray imaging where X-ray quantum noise is low frequency dominated. To solve this problem, a multi-resolution representation is chosen. Adaptive filtering is performed on the Laplacian pyramid images. The gradients controlling the filter process are derived from the next coarser layers of the Gaussian or Laplacian Pyramid images. In this way, the required smoothing of the gradients is easily achieved. Since the smoothed gradient allows to distinguish between structure and noise, its size can be used for additional noise reduction and edge enhancement by selectively damping or amplifying the band pass signal of the Laplacian Pyramid layer.

The present invention introduces a new de-noise algorithm: Multi-Resolution gradient adaptive filter (MRGAF). The following part discusses the algorithm.

Gradient Calculation:

In order to base the adaptive filtering on a less error prone gradient estimation, the gradient vector field for filtering level I from the next coarser layer l+1 of the Gaussian Pyramid images is calculated. To this end, y and x gradient vector field Gradₗ^{y}(i, j), Gradₗ^{x}(i, j)is defined, wherein

$${Grad}_{l}^{y} ( 2 m + 1 , 2 n ) = \frac{1}{2} ( {g}_{l + 1} ( m + 1 , n ) - {g}_{l + 1} ( m , n ) ) and$$

$${Grad}_{l}^{x} ( 2 m + 1 , 2 n ) = \frac{1}{2} ( {g}_{l + 1} ( m , n + 1 ) - {g}_{l + 1} ( m , n ) ) .$$

The remaining x and y gradient vector field values are obtained by Interpolation. Using the Gaussian Pyramid images for calculating gradients has the disadvantage that a smooth linear gray level slope in the image will also result in a non-zero gradient causing in an anisotropic filtering with reduced noise reduction performance. An alternative would be to use the Laplacian Pyramid images instead of the Gaussian Pyramid images for gradient calculation.

$${GradLaplacian}_{l}^{y} ( m + \frac{1}{2} , n ) = \frac{1}{2} ( {L}_{l + 1} ( m + 1 , n ) - {L}_{l + 1} ( m , n ) )$$

$${GradLaplacian}_{l}^{x} ( m , n + \frac{1}{2} ) = \frac{1}{2} ( {L}_{l + 1} ( m , n + 1 ) - {L}_{l + 1} ( m , n ) )$$

In this embodiment, the adaptive filtering is performed starting at level N−2 since level for level N−1, no gradient from the next coarser layer is available. The adaptive de-noise filter relation is shown as below.

$${FilteredLaplacian}_{l} ( m , n ) = \frac{{\sum }_{Δ y = - 1}^{1} {\sum }_{Δ x = - 1}^{1} α ( m , n ; Δ y , Δ x ) {L}_{l} ( m + Δ y , n + Δ x )}{{\sum }_{Δ y = - 1}^{1} {\sum }_{Δ x = - 1}^{1} α ( m , n ; Δ y , Δ x )} .$$

The adaptive filter is based on a binomial 3-by-3 filter kernel applied to each level of the Laplacian Pyramid images. Each of the adaptive filter coefficients α(m,n;Δy,Δx) is gradually reduced depending on how far the filter direction is in line with the gradient and on the size of the gradient. Let the adaptive filter coefficients

$$α ( m , n ; Δ y , Δ x ) = \frac{β ( Δ y , Δ x )}{c + {( {Grad}_{l}^{y} ( m , n ) Δ y + {Grad}_{l}^{x} ( m , n ) Δ x )}^{2}}$$

be filter coefficient, i.e. the each adaptive filter coefficient α(m,n;Δy,Δx) reduction is controlled by the scalar product of the gradient β(Δy,Δx)=2^{-(2+|Δx|+|Δy|)}, where in this embodiment the size representing the standard 3-by-3 binomial filter kernel. The constant c is an adjustable parameter defining from which gradient size on the image structure is regarded as significant enough to start with anisotropic filtering.

This basic formula has to be further modified to take into account the following problems. (1) Anisotropic filtering must not be effective if the gradient size is not significantly above its noise level. (2) The directional sensitivity must be limited to allow at least some filtering perpendicular to the gradient. (3) Otherwise, filtering would be completely switched off for very large gradients if the gradient direction is not exactly a multiple of 45°. Since filtering is performed on band pass images and these images represent local intensity variation, further noise reduction and image enhancement can be achieved by attenuating band pass coefficients at places where no significant image structures are present and amplifying them where edges are present. The amount of such image structures can be measured by the sum of the adaptive filter coefficients

$${\sum }_{Δ y = - 1}^{1} {\sum }_{Δ x = - 1}^{1} α ( m , n ; Δ y , Δ x ) ,$$

which has to be calculated anyway. Large gradients produce how adaptive filter coefficients along the gradient thus reducing the adaptive filter coefficients sum

$${\sum }_{Δ y = - 1}^{1} {\sum }_{Δ x = - 1}^{1} α ( m , n ; Δ y , Δ x ) .$$

This approach may be interpreted as giving each point a continuous-scaled (fuzzy) attribute “noise only” or “edge”, and damping or amplifying the band pass coefficients to the adaptive filter coefficients α(m,n;Δy,Δx) accordingly.

Edge Enhancement

The multi-scale representation is very suited for implementing conventional filters such as edge enhancement or low-frequency attenuation. The latter is used for reducing the dynamic range, and is further referred to as latitude reduction. In fact, any frequency response can be easily synthesized by appropriately weighing the Laplacian Pyramid coefficients z according to the layer to which they belong, since each layer is associated with an octave of the spatial frequency spectrum. In this embodiment, the algorithm contrast equalization is the basic mode of enhancement, and in most examination cases it is the only mode. If additional edge enhancement or latitude is required, they are realized by concatenation. Starting from the Laplacian Pyramid coefficients z, contrast equalization and/or de-noise are applied to all layers. Next each layer is multiplied by scale-dependent factors αeₖ for edge enhancement.

Edge enhancement is implemented by multiplying the pyramid coefficients of the small-scale layers with a scale-dependent factor,

αeₖ=fₗ^{(1-k/n}^{ₗ}⁾, 0≦k<nₗ

αeₖ=1, nₗ≦k≦N

in which fₗ is the parameter that controls the degree of edge enhancement at the finest scale, i.e. at which the scale index k is zero, and nₗ is the number of Laplacian Pyramid images layers (octaves) to which edge enhancement is applied. In this embodiment, the value of the nₗ is equal to the value of the N. This means that the edge enhancement increases at a rate of ⁿ^{ₗ}\sqrt{fₗ} per octave, equally distributed among the octaves of the high end of the spectrum. With this gradual filter characteristic, it is possible to minimize rebound in the vicinity of steep density transitions.

Nonlinear Mapping

Many images, such as medical images, remote sensing images, electron microscopy images and even our real-life photographic pictures, suffer from poor contrast. Therefore, it is very necessary to enhance the overall contrast of such images after further processing or analysis can be conducted. There have already been many techniques for enhancing image contrast. The most widely used methods include various contrast manipulations and histogram equalization. Classic contrast manipulation is usually based on a globally defined stretching function (or called transfer function in the following). Histogram clipping might be needed before pixel-by-pixel stretching. Traditionally histogram equalization is also a global technique in the sense that the enhancement is based on the equalization of the histogram of the entire image. However, it is well recognized that using only global information is often not enough to achieve good contrast enhancement (for example, global approaches often cause an effect of intensity saturation). In the present invention, a fast method is proposed for enhancing the original image contrast, for example between soft tissue and bone. The basic idea of the present invention is to design a transfer (or mapping) function for each pixel based on the information of input image data. The method of the present invention follows the idea of nonlinearly mapping.

The dynamic range of digital image detector for example digital radiograph detector is very large in comparison with the available density range of view-boxe or display screen under normal ambient light conditions. Without image processing, this mismatch would cause a significant additional loss of pictorial information in the digital radiograph image chain. It will be shown in the previous subsections how special enhancement techniques in addition to adjusting global density, contrast, and gradation can help to maximize the transform of image information to the viewer. Ordinary, digital radiograph image data is 14 bits and have big dynamic range. And noise is in the lower gray level, image information lies in the upper gray level. But the display device only has the display ability of 8 bits. So suffering from losing some information, the nonlinear mapping is employed to suppress noise and preserve detail.

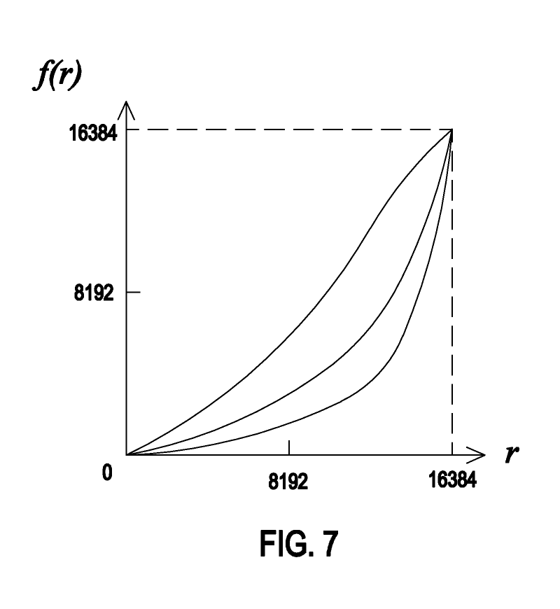

Please refer to FIG. 7, which is the various nonlinear mapping curve according to the preferred embodiment of the present invention. The formula of curve is y=f(r). r represents input data i.e. data processed and reconstructed. Y represents output data with transfer or mapping function. And f is transfer and mapping function. Finally, according to window/level or look up table, 14 bits data can be transferred to 8 bits data for display or viewer. FIG. 6 shows some kinds of curves (e.g., exponent, power, log, sigmoid etc).

From the above descriptions, the present invention proposes an improved image enhancement algorithm via the Laplacian Pyramid, which uses the contrast equalization, edge enhancement, de-noise and so on to deal with different parts of each Laplacian Pyramid scale and different scales of Laplacian Pyramid. The objective of this algorithm is to emphasize the medium-contrast details of each stage and the objective enhancement is to enhance the details with lower magnitude more than the details with higher magnitude. Experimental results show that the contrast improvement ratios (CIRs) of most images are increased while preserving the good visual assessment of X-ray images. The present invention chooses Laplacian Pyramid transformation as multi-scale kernel. Then it process edge coefficient at each Laplacian Pyramid layer. It has the advantage that the image is only expanded to 4/3 of the original size and that the same (small) filter kernel can be used for all Laplacian Pyramid levels.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image processing method, comprising the steps of:
(a) decomposing an original image into a plurality of detail images at successive resolution levels;
(b) enhancing image contrast and reducing noise of each said detail image; and
(c) reconstructing said processed detail images into an output image.

2. The image processing method according to claim 1, wherein said step (a) and said step (c) are performed by using Laplacian Pyramid, and said plurality of detail images are Laplacian Pyramid images.

3. The image processing method according to claim 2, wherein said step (a) comprising the steps of:
(a1) decomposing said original image into a plurality of reduced images at successively smaller size;
(a2) interpolating said plurality of reduced images into a plurality of expanded images; and
(a3) generating at least one of said plurality of detail images by subtracting one of said plurality of expanded images of a given size from one of said plurality of reduced image of said given size.

4. The image processing method according to claim 3, wherein said reduced images are multi-resolution images with successive resolution levels.

5. The image processing method according to claim 4, wherein said multi-resolution images are Gaussian Pyramid images, and the level 0 of said multi-resolution images is said original image and top level.

6. The image processing method according to claim 4, wherein said step (a1) is performed by a reduce operator for low-pass filtering and decreasing resolution of at least one of said multi-resolution images.

7. The image processing method according to claim 6, wherein said low-pass filtering is performed by the weighting function.

8. The image processing method according to claim 7 wherein said weighting function is symmetric.

9. The image processing method according to claim 7 wherein the member of said weighting function is Gaussian probability distribution.

10. The image processing method according to claim 7 wherein the size of said weighting function is 5 by 5 pattern.

11. The image processing method according to claim 4, wherein said step (a2) is performed by an expand operator for up-sampling and low-pass filtering at least one of said multi-resolution images.

12. The image processing method according to claim 4, wherein said step (b) of enhancing image contrast of each said detail image is performed by using nonlinear amplification to modify the coefficients of Laplacian Pyramid.

13. The image processing method according to claim 4, wherein said step (b) of reducing noise of each said detail image is performed by a multi-resolution gradient adaptive filter.

14. The image processing method according to claim 13, wherein said multi-resolution gradient adaptive filter includes at least one adjustable filter coefficient, which is dependent on a gradient information obtained from said multi-resolution images or said detail images, to be modified for reducing noise of each said detail image.

15. The image processing method according to claim 4, wherein said step (b) further comprising step (b1) of enhancing edge of each said detail image.

16. The image processing method according to claim 15, wherein said step (b1) of enhancing edge of each said detail image is performed by modifying the pyramid coefficients of said Laplacian Pyramid.

17. The image processing method according to claim 1, further comprising step (d) of performing a nonlinear mapping process to said output image for transferring said output image to be displayed via a display.

18. An image processing device for processing an original image into an output image, comprising:
an image decomposing section configured to receive said original image and decompose said original image into a plurality of detail images at successive resolution levels;
an image processing section coupled to said image decomposing section for enhancing image contrast and reducing noise of each said detail image; and
an image reconstructing section coupled to said image processing section for reconstructing said processed detail images into said output image.

19. The image processing device according to claim 18, further comprising a nonlinear mapping section coupled to said image reconstructing section for transferring said output image to be displayed via a display.

20. An X-ray examination apparatus, comprising:
an image picking-up device for picking-up an original image;
an image processing device coupled to said image pick-up device and comprising an image decomposing section configured to receive said original image and decompose said original image into a plurality of detail images at successive resolution levels, an image processing section coupled to said image decomposing section for enhancing image contrast and reducing noise of each said detail image; and an image reconstructing section coupled to said image processing section for reconstructing said processed detail images into said output image; and
an image output device coupled to said image processing device for outputting said output image.

21. The X-ray examination apparatus according to claim 20, wherein said image processing device further comprises a nonlinear mapping section coupled to said image reconstructing section for transferring said output image to be displayed via a display.
